(19) United States
(12) Patent Application Publication
(10) Pub. No.: US 2015/0222614 A1
(43) Pub. Date: Aug. 6, 2015

(54) AUTHENTICATION SERVER AUDITING OF CLIENTS USING CACHE PROVISIONING

(71) Applicant: Microsoft Technology Licensing, LLC, Redmond, WA (US)

(72) Inventors: Gregory C. Johnson, Bellevue, WA (US); William S. Jack, Redmond, WA (US); Nathan D. Muggli, Redmond, WA (US); Tarek B. Kamel, Issaquah, WA (US)

(73) Assignee: Microsoft Technology Licensing, LLC, Redmond, WA (US)

(21) Appl. No.: 14/689,931

(22) Filed: Apr. 17, 2015

Related U.S. Application Data
(63) Continuation of application No. 11/585,739, filed on Oct. 23, 2006.

(51) Int. Cl. H04L 29/06

(52) U.S. Cl. CPC H04L 63/062; H04L 63/0807

(57) ABSTRACT

Sharing resources on a network include, for example, a domain controller hierarchy scheme, which is used in some implementations to organize and share both secure and non-secure resources in an efficient manner. Using authentication information can be used to architect a trustworthy system to divulging sensitive client data (such as user/computer passwords) to a host system. The sensitive client data can be released to the host system when a client establishes a relationship having a degree of trust with the host.

### CROSS-REFERENCE TO RELATED APPLICATIONS

This application is a continuation application of, and claims priority to, prior non-provisional patent application Ser. No. 11/585,739, filed Oct. 23, 2006, entitled “AUTHENTICATION SERVER AUDITING OF CLIENTS USING CACHE PROVISIONING,” which application is incorporated herein by reference in its entirety.

### BACKGROUND

Sharing resources on a network include, for example, a domain controller hierarchy scheme, which is used in various implementations to organize and share both secure and non-secure resources in an efficient manner. For example, a central hub domain controller might be used to manage user names, passwords, computer names, network identifiers, or the like, and provide the information through a hierarchy of remote and local servers (i.e., local domain controllers). The various domain controllers, in turn, are configured with a Security Account Manager (“SAM”), which provides interfaces and storage for holding or passing along security information within the domain hierarchy. When one or more individual client computer systems requests a resource, the request may be passed along the hierarchy before the user receives a response.

Hub domain controllers are usually writable or configured to be written-to by an administrator in a main organization to which a branch domain belongs. The local domain controllers to which the central writable domain controller are connected in the branch domain, however, are typically “read-only,” and are therefore not usually configured to be written-to by the local users, or perhaps by even the network administrator. Each local domain controller is typically configured, for example, to pass along user requests (such as a logon request) to the writable hub domain controller, and then pass along the relevant account approval information sent back from the hub domain controller. As an example, a user can log onto a client machine having an association with a local domain controller, which in turn forwards the request to the hub domain controller for authentication. If the hub domain controller verifies the user's entered information, the hub domain controller instructs the local domain controller to allow the user to logon to the client computer system.

While the network architecture as described above is relatively centralized, it also has a lower degree of local configurability (or none at all) for the various local domain controllers. For example, in order for a user to change a password (or reconfigure another resource), the user will usually need to contact an administrator managing the hub domain controller, who will then change the password (or resource) at the hub domain controller before the user can use the new password (or resource) at the local branch. Furthermore, although minimizing the amount of technical support staff needed at the local branch, this centralized domain controller schematic represents a single point of failure throughout the entire company's network. For example, when the hub domain controller is unavailable for any reason, users at the local branch might be unable to access a certain resource (e.g., logon to their respective client computer systems), since the local domain controller does not normally store the given information necessary to validate the client's request.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The present disclosure is directed to a trustworthy system in which sensitive client data (such as user/computer passwords) can be divulged to a host system. The sensitive client data can be released to the host system when a client establishes a relationship having a degree of trust with the host. The host system can use a security protocol (such as Kerberos, as shown in the below example embodiments) to obtain passwords or other sensitive data related to the client.

In an embodiment, a user on a client system can attempt to gain access to a host system. The host system can use specific elements of a Kerberos ticket exchange between the host and the client to approximately determine the client physical locality. (Kerberos servers can be assigned via routing tables which prefer available servers that are in close proximity to the client.) The client information gathered by the Kerberos ticket exchange can be tracked and stored on the host server in a secure fashion for purposes of security and management of the user. Because the information is tracked, the information can be used to dynamically grant access having levels of security that are appropriate for the user being tracked.

A list of successfully authenticated clients can be created according to the specific Service Principal Name (SPN), such as HOST, LDAP, GC and the like, in a request made to the host system. The list can be used to automatically cache client credentials in the host. The host can be used to effect a “trust equivalency,” whereby the client (who trusts the host) can have the client's identity assumed by the host by using the client credentials. The period of trust equivalency can be limited for the duration of the current identity and/or current password of the client.

Tracking the physical locality of clients by using the knowledge of the client trust to the host system in the ticket exchange allows tracking that does not involve directly trusting the host a priori. This knowledge is therefore useful in determining the names of clients in a given physical region that trust the host. The knowledge can be used by the system to define a group of clients for which the host is allowed to receive privileged information. Clients in the system can find the host through mechanisms that leverage a network topology and latency indicators to find a physically close host among many different hosts that serve the same role.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIG. 1 is an illustration of an example operating environment and system for authentication server auditing of clients using cache provisioning.

FIG. 2A is a schematic diagram of a domain controller hierarchy showing one or more central hub domain controllers connected over a network to one or more local domain controllers at corresponding one or more branch locations.

FIG. 2B is the domain controller hierarchy as shown in FIG. 2A, in which a user at a local branch attempts to logon to a client computer system.

FIG. 3 is a top-level illustration of a flow diagram for authentication server auditing of clients using cache provisioning.

### DETAILED DESCRIPTION

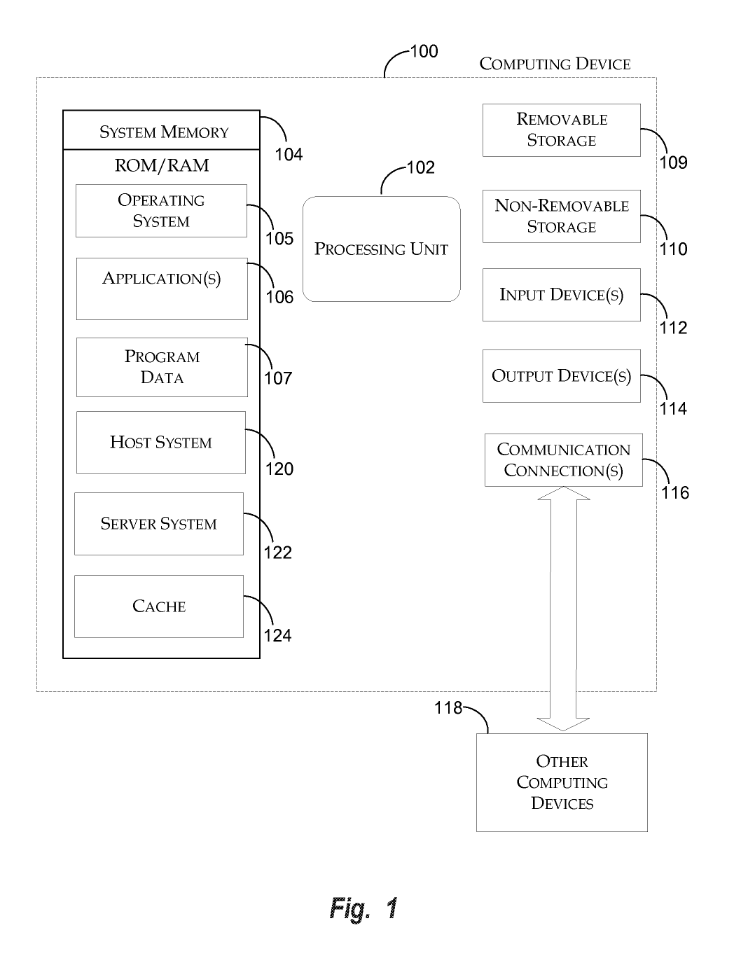

As briefly described above, embodiments are directed to dynamic computation of identity-based attributes. With reference to FIG. 1, one example system for managed code assemblies includes a computing device, such as computing device 100. Computing device 100 may be configured as a client, a server, a mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107 such that host 120, client 122, and cache 124 can be implemented (which are discussed below).

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

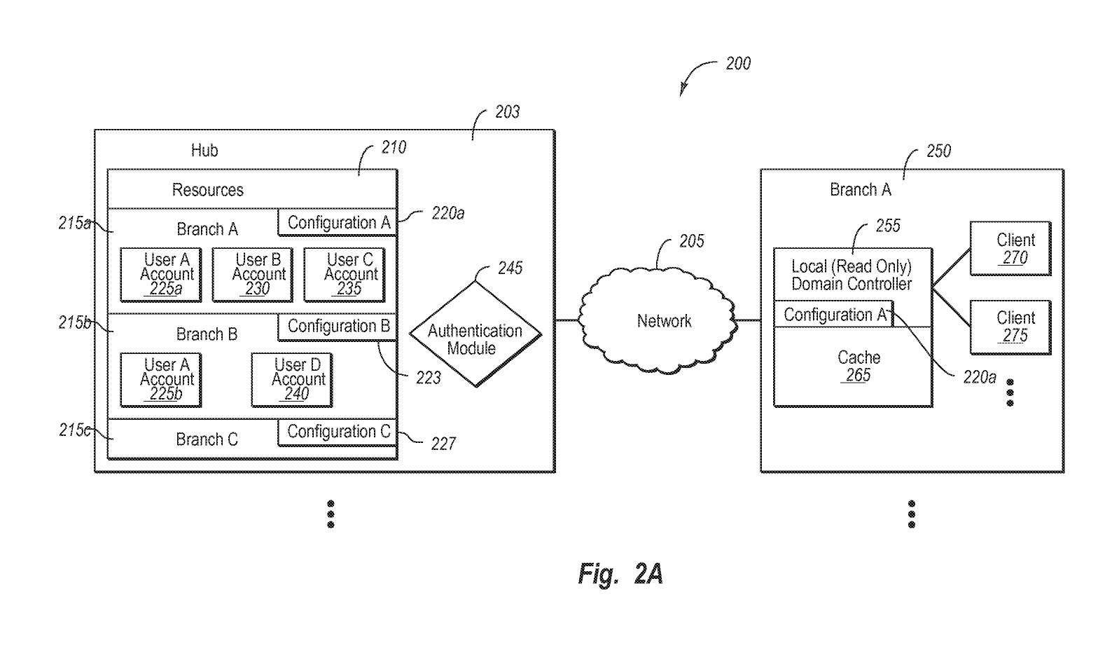

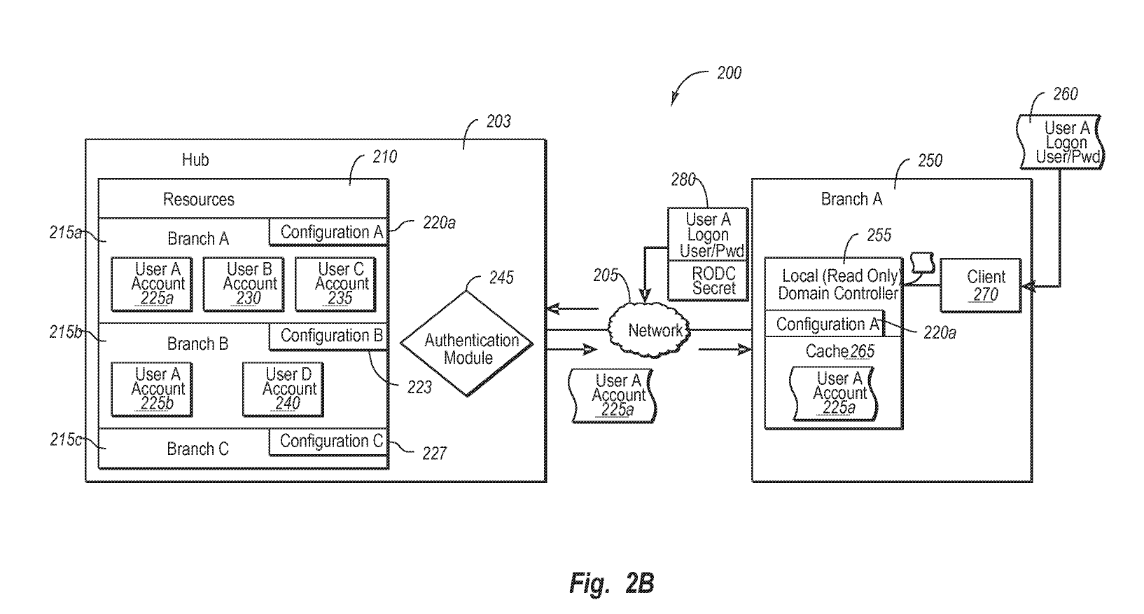

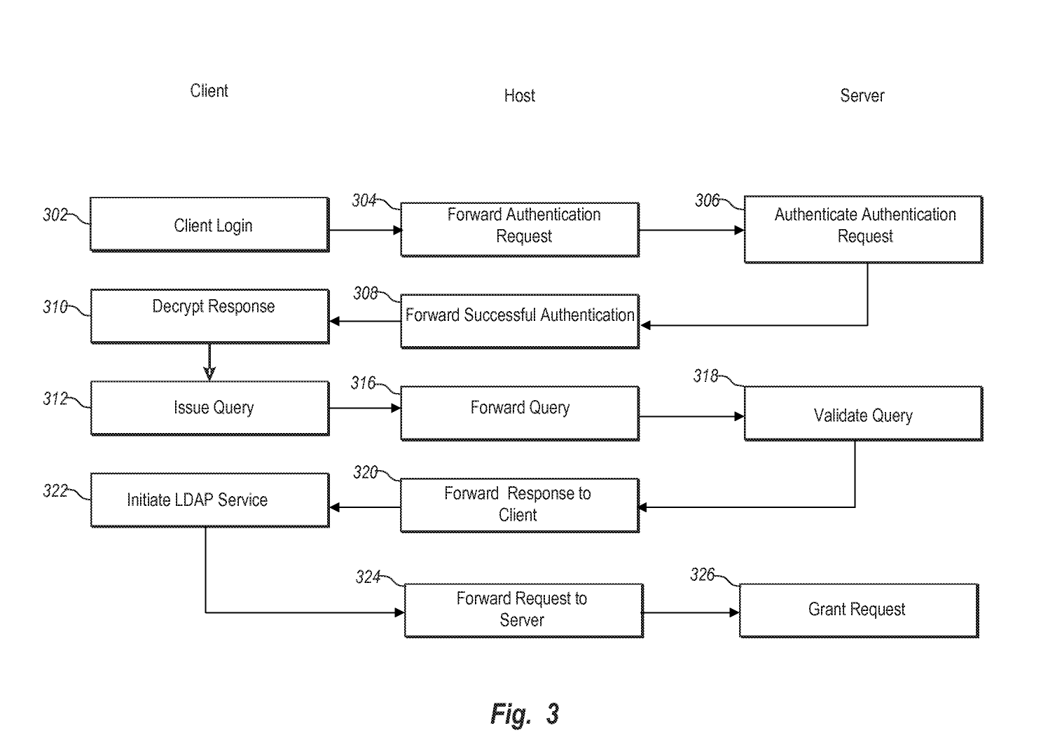

In accordance with the discussion above, computing device 100 system memory 104 (and processor 102, and related peripherals can be used to implement host 120, server 122, and cache 124. Host 120, Server 122, and cache 124 in an embodiment can be used for authentication server auditing of clients using cache provisioning (described below with reference to FIGS. 2-3). Host 120 can be used receiving and forwarding an authentication request from a client, wherein the authentication request comprises affinity information for approximating a physical locality of the client. Server 122 (which is normally on a different computer than host 120) can be used for receiving and authenticating the authentication request forwarded from the client. Cache 124 is usually associated with host 120 and can be used for persisting information associated with a successfully authenticated authentication request.

FIG. 2A is a schematic diagram of a domain controller hierarchy showing one or more central hub domain controllers connected over a network to one or more local domain controllers at corresponding one or more branch locations. As can be understood more fully from the following specification and claims, a company or organization can place domain controllers in a local branch. For example, in one implementation, each local branch is provided with a Read-Only Domain Controller (“RODC”) that is essentially independent compared to other local domain controllers in a domain controller hierarchy. The local (read-only) domain controller can only be written-to by a central hub domain controller. As such, the local domain controller cannot normally be written-to by a local user, by another user at another local domain controller, or even by a malicious user from an outside network. This provides a number of security and ease-of-use limits on potential liabilities from misuse.

In addition, the local (read-only) domain controller is configured to only store the resources (e.g., user accounts “secrets”) that are needed for that branch location. For example, as will be understood more fully from the following specification and claims, the hub domain controller partitions for each branch which users can login to client computer systems at the given branch. The hub domain controller, however, does not automatically provide these resources to all local domain controllers at each branch, but provides only those authorized secrets to the given branch upon an appropriate login by the user. Thus, in one implementation, the local (read-only) domain controller is configured to receive and store only a select few of the company's or organization's secrets, which can limit the potential security exposure of the server.

For example, FIG. 2A illustrates a domain controller system 200, where one or more central hub domain controllers (e.g., 203) are connected to one or more local (read-only) domain controllers (e.g., 255) at one or more corresponding local branches 250 over a network 205. In general, the hub domain controller 203 is writable, meaning that an authorized network administrator can write, change, update or delete configuration preferences, user accounts, and/or a variety of other components at the hub domain controller 203. By contrast, the local (read only) domain controller 255 cannot generally be written-to except from a trusted source (e.g., the hub domain controller 203) in the domain hierarchy 200, but not typically from another user at the branch, or from another local domain controller.

As shown, the hub domain controller 203 includes a resources component 210, which comprises all of the configuration, non-secret, and secret information that is used or available with each branch domain controller (e.g., 255). For example, in one implementation, the resources component 210 contains user accounts in the company or organization, including the corresponding user names and passwords. The resources component 210 also contains user name and password versioning information, as well as versioning information for various configuration information used at a given branch. The hub domain controller 203 is configured to change configuration resources and/or location of resources/secrets for each different local domain controller.

For example, FIG. 2A shows that the resources component 210 has a partition for “Branch A” 215a that identifies “Configuration A” 220a information, and includes “User Account A” 225a, “User Account B” 230, and “User Account C” 235. The resources component 210 also includes a partition for “Branch B” 215b that identifies “Configuration B” 223 information, and includes “User Account A” 225a, and “User Account D” 240. The resources component 210 further includes a partition for “Branch C” 215c that identifies at least “Configuration C” 227 information. Notably, FIG. 2A shows that “User Account A” 225a is present in both the branch 215a and branch 215b partitions since the corresponding user is allowed to access client computer systems at both branches. For example, the user is a company manager visiting a given branch office in the company later in the day.

FIG. 2A also shows a branch office 250 having a local (read-only) domain controller 255 (or “local domain controller”) that is connected to one or more client computer systems 270 and 275. In at least one implementation, the local domain controller is read-only to protect the computer system from malicious or inadvertent configuration errors, as well as to protect other problems that can occur when inappropriately written-to by a local user, or otherwise non-trusted source. FIG. 2A further shows that the local domain controller 255 comprises at least configuration information 220a received from the hub domain controller 203, as well as a cache 265 for storing secrets, such as resources (e.g., secure user accounts), or the like. In particular, FIG. 2A shows that the local domain controller 255 is in a default configuration, where no local user accounts are stored in cache 265.

Thus, as shown in FIG. 2B, when a user at the local branch 250, such as a generic employee or a local administrator, attempts to logon to a client computer system 270, the logon request 260 is not necessarily authenticated directly by the local domain controller 255. Rather, the local domain controller 255 passes the logon request 260 with the local domain controller's secret in a separate message 280 through a secure communication channel. (The local domain controller 255 can also be configured to perform basic, preliminary authentication measures to ensure that random unauthorized users do not attempt to pull secrets from the hub domain controller by spoofing accounts). In one implementation, the local domain controller's secret is a secret provided previously by the hub domain controller 203, and accessible only to the local domain controller 255. The message 280 is ultimately then received and processed by an authentication module 245 at the hub domain controller 203.

The authentication module 245 identifies whether the local domain controller's secret and the user's logon credentials provided in message 280 are authentic and current. If either the local domain controller's secret or the user's logon credentials are not current, not valid, or not authentic for some other reason, the hub domain controller 203 returns an error to the local domain controller. Assuming, nevertheless, that the local domain controller's secret is valid, the authentication module 245 also checks to see if “User A” is allowed to access the resource (e.g., logon) at “Branch A” 250. For example, if User A is allowed to logon at Branch B (not shown), but not allowed to logon at the requested branch (i.e., “Branch A”), the authentication module 245 might allow the login, but will not allow the branch domain controller to cache the user's secret (e.g., user account 225a). Alternatively, the hub domain controller can return an error, if appropriate.

As shown in FIG. 2B, the local domain controller secret and the user's provided logon credentials (e.g. message 260) are valid. In addition, the user account 225b is found in the partition 215a for the Branch A domain controller. As such, the authentication module 245 of the hub controller 203 returns the current user account 225a to the local domain controller 255 through a secure communication channel. That is, the hub domain controller 203 returns the user account 225a back to the local domain controller 255, along with a message indicating the user's initial logon 260 was acceptable. Upon receipt, the local domain controller 255 then stores the user account 225a in cache 265, and tells (not shown) the client computer system 270 to allow access to the user. Since the local domain controller 255 now has the user's account 225a in cache 265, the local domain controller 255, rather the central hub domain controller 203, can handle future logon requests by this user for the action (i.e., logon request in this case).

As such, FIGS. 2A and 2B show that the local domain controller 255, and hence the local branch 250, are only given cacheable access to a secret upon a valid request by a user who is allowed to logon at the particular branch, and who is allowed to have an account cached at the branch. Thus, potential liability is limited even in situations where another malicious person might try to simulate all possible logon requests at a given branch, and “pull” those accounts down to the branch. In particular, secure account information can only be “pulled” when properly authenticated in multiple levels (e.g., basic authentication at the local level, full authentication of secrets at the hub domain controller, and/or verification of appropriate cacheability status for the local domain controller and the user).

The illustrated “as needed” or “on-demand” type of approach, however, is not required in all situations. For example, an authorized branch manager (of another branch) or company president may be visiting branch 250 that day, and will need to access one or more of the client computer systems for presentation purposes. An authorized user, such as the local network administrator for the local domain controller, can request the visitor's account in advance. For example, the local network administrator can send a request through the local domain controller 255, or through another local client computer system (e.g., 270) to the hub that requests the visitor's account.

As with prior requests, the request for advanced access also includes authentication information for the requestor, as well as the secret for the local domain controller provided earlier by the hub domain controller 203. The authentication module 245 at the hub domain controller 203 then checks to see if the visitor's account is one that can be provided in advance, and, if appropriate checks the credentials of the requester. For example, the hub domain controller can check the requester's credentials if the requester has not yet been cached at the local domain controller where the requester is making the request.

In addition, the hub domain controller 203 can check to see if the secret provided by the local domain controller is accurate. If appropriate, the hub domain controller 203 then passes the visitor's user account to the local domain controller, where it can be stored in cache 265 for an appropriate amount of time. When that amount of time has expired (e.g., when periodic updates are scheduled to be sent and received next), the hub domain controller can send information that invalidates the metadata of the secret received in advance. As will be understood more fully from the following text and claims, the messaging invalidating the secret's metadata itself comprises one or more timestamps to ensure proper ordering, prioritization, and discarding of invalid secrets cached or received by the local domain controller.

In an implementation using Kerberos, the login process of a client includes finding a Key Distribution Center (KDC) by using indirection. Using indirection in the login process typically does not specifically target a unique KDC, but rather uses a generic name that will return any KDC available, and typically nearby. This allows automatic affiliation between the KDC and the client—but this affiliation is normally unknown to the client (which normally only knows that the request is sent to an arbitrary KDC).

The first information passed is an AS_REQ (authentication server request) from the client to the KDC. This is information that can identify the client to the KDC, and normally has a limited lifetime. These messages can be snooped upon by unauthorized parties, and because the messages are also sent independently to other KDCs, they are not typically good identifiers of client affinity to a specific KDC.

The KDC responds with an encrypted package for the client identified by the AS_REQ. This package is normally only decryptable by someone holding the client's password (not available from the AS_REQ alone)—which in an embodiment is the identified client itself. The contents of the package are a typically a session key and a TGT (ticket granting ticket).

Further, when the client wishes to make a connection to some resource (such as another client, computer, resource, and the like), it creates a request and encrypts it with the session key, and includes the TGT. This request, called a TGS (ticket granting server) request can be copied and sent to other KDCs, but the internal information, the session key, the TGT, the identification of the resource requested, and the type of service requested are very resistant to being modified or spoofed (at least by network sniffing). Therefore, the TGS request itself is not a good identifier of client affinity to a specific KDC, but the data in the TGS can be used as an identifier of the client affinity. Specifically, the identity of the resource requested and the type of service requested are good identifiers of client affinity to a specific KDC.

In a Windows® logon process, a client typically requests from the affiliated KDC the services of LDAP (lightweight directory access protocol) or HOST. These are normally used for querying a Group Policy or downloading a Group Policy. Therefore, if the rule is used that whichever client, in an authorized list for a specific KDC, requests an LDAP or HOST service from that KDC in a TGS_REQUEST that is allowed to be cached, the list for tracking approximate client physical locality will be automatically created as described above.

Because the user who is logging in is by definition not already cached, all requests of the caching-KDC are forwarded to a full KDC. Accordingly, a full KDC makes the decision whether to allow caching of the TGS_REQUEST information. If the list of clients that are to be allowed to have their information and passwords cached at any single KDC is too broad, for example if too many users are allowed or a large superset of the actual physically local users, a large part of the benefit knowing the client affinity can be lost. If a very small set of clients, which directly relate to the actual physically local users and computers, is used then the security of the solution is maximized.

However, independently managing such a small list for each locale for any large or dynamic organization can be time-consuming and error prone. One question is how to automatically create the list of allowed users, while ensuring the system is secure. In an embodiment, a second list of clients who are authorized to be allowed to be cached is kept, which adds a (simplifying) level of indirection to the process. This list can be relatively large, and can include all possible clients except those explicitly denied (this list is relatively easy to manage, and in fact already is in many environments). When the large list is used, a determining factor becomes, of those who are authorized by the large list, who should be allowed to be cached. A “deny list” can also be used. As discussed above, clients that have their locations approximated via the affinity with a particular KDC can thus be cached with a level of trust.

FIG. 3 is a top-level illustration of a flow diagram for authentication server auditing of clients using cache provisioning. In operation 302, a first client who wishes to logon sends an AS_REQ, encrypted with their password to a nearby caching-KDC. The AS_REQ can be vetted to a single KDC using a locator mechanism such that the located KDC is unknown to the client.

In operation 304, it is determined that the client is not cached at the caching-KDC, and because the AS_REQ cannot be locally processed, the AS_REQ request is forwarded to a full KDC.

In operation 306, the full KDC validates the AS_REQ as if it had directly originated with the first client. If the validation is successful, the full KDC creates a response, which includes a session key and a TGT, and encrypts the response with the client password. It sends this to the caching-KDC from which it received the forwarded AS_REQ request. In operation 308, the caching-KDC returns it intact to the client, and in operation 310, the client receives the response and decrypts it.

In operation 312, the first client wishes to query about the Group Policy as part of the logon process. The first client creates a TGS_REQUEST for the LDAP service on the caching-KDC. The TGS_REQUEST is sent (comprising server and service information, along with the TGT), encrypted with the session key to the caching-KDC itself.

In operation 316, the caching-KDC verifies that it cannot read the session key to be able to decrypt the request, and the request is forwarded it to the full KDC.

In operation 318, the full KDC decrypts the information and validates the request that came from the original client by using the correct session key, and a valid TGT. The full KDC notes that the request is for the LDAP service on the caching-KDC, and marks that client to be allowed to be cached by the caching-KDC. The full KDC responds to the request appropriately, and sends the info to the caching-KDC.

In operation 320, the caching-KDC forwards the response from the full KDC to the client.

In operation 322, the client initiates a connection to the LDAP service on the caching-KDC using the Kerberos information in the TGS response.

In operation 324, the caching-KDC (because the client made an LDAP service request) requests of the full KDC that it be allowed to cache the client's information and password.

In operation 326, the full KDC determines that the client has been marked to be cached by the caching-KDC, and grants the request, sending the caching-KDC the requested information and passwords. Further requests (for TGSs to other site affiliated resources and for additional AS_REQs and TGT requests) from the client to the caching-KDC can be serviced by the caching-KDC itself, with no forwarding required.

The above specification, examples and data provide a complete description of the manufacture and use of embodiments of the invention. Since many embodiments of the invention can be made without departing from the spirit and scope of the invention, the invention resides in the claims hereinafter appended.

1.-20. (canceled)

21. A computer implemented method, the method comprising:
receiving an availability request from a client;
sending an encrypted secret to the client, wherein the encrypted secret includes a secret that is decryptable using a key;
receiving a resource request from the client, wherein the resource request includes the secret;
after receiving the resource request that includes the secret, caching information about the client.

22. The method of claim 1 further comprising:
after receiving the availability request from the client, determining that information about the client is not cached;
sending the availability request to a hub domain controller;
in response to sending the availability request to the hub domain controller, receiving the encrypted secret from the domain hub controller;
after receiving the resource request from the client, verifying that the resource request cannot be decrypted;
sending the resource request to the hub domain controller;
in response to sending the resource request to the hub controller, receiving information regarding the resource;
sending the information regarding the resource to the client;
prior to caching the information about the client, sending a caching request to the central hub controller to cache information about the client;
in response to sending the caching request, receiving permission to cache the information about the client.

23. The method of claim 21, wherein the encrypted secret includes a ticket granting ticket and a session key.

24. The method of claim 21 wherein the key is a client password.

25. The method of claim 22 further comprising:
in response to sending the caching request, receiving a second secret and the key from the hub domain controller.

26. The method of claim 25, further comprising:
receiving a second resource request from the client;
determining information about the client is in the cache;
encrypting the second secret with the key;
after encrypting the second secret with the key, sending the second secret to the client.

27. The method of claim 21, wherein the resource request comprises a request to access another client computer.

28. A system, the system comprising at least one processor operatively connected to a computer storage device, the computer storage device having instructions that, when executed by the at least one processor, cause the at least one processor to perform a method, the method comprising:
receiving an availability request from a client;
sending an encrypted secret to the client, wherein the encrypted secret includes a secret that is decryptable using a key;
receiving a resource request from the client, wherein the resource request includes the secret;
after receiving the resource request that includes the secret, caching information about the client.

29. The system of claim 28, the method further comprising:
after receiving the availability request from the client, determining that information about the client is not cached;
sending the availability request to a hub domain controller;
in response to sending the availability request to the hub domain controller, receiving the encrypted secret from the domain hub controller;
after receiving the resource request from the client, verifying that the resource request cannot be decrypted;
sending the resource request to the hub domain controller;
in response to sending the resource request to the hub controller, receiving information regarding the resource;
sending the information regarding the resource to the client;
prior to caching the information about the client, sending a caching request to the central hub controller to cache information about the client;
in response to sending the caching request, receiving permission to cache the information about the client.

30. The system of claim 28, wherein the encrypted secret includes a ticket granting ticket and a session key.

31. The system of claim 28, wherein the key is a client password.

32. The system of claim 29, the method further comprising:
in response to sending the caching request, receiving a second secret and the key from the hub domain controller.

33. The system of claim 32, the method further comprising:
receiving a second resource request from the client;
determining the information about the client is in the cache;
encrypting the second secret with the key;
after encrypting the second secret with the key, sending the second secret to the client.

34. The system of claim 32, wherein the resource request comprises a request to access another client computer.

35. A computer storage device having instructions that when executed are capable of performing the method of:
receiving an availability request from a client;
sending an encrypted secret to the client, wherein the encrypted secret includes a secret that is decryptable using a key;
receiving a resource request from the client, wherein the resource request includes the secret;
after receiving the resource request that includes the secret, caching information about the client.

36. The computer storage device of claim 35 further comprising:
after receiving the availability request from the client, determining that information about the client is not cached;
sending the availability request to a hub domain controller;
in response to sending the availability request to the hub domain controller, receiving the encrypted secret from the domain hub controller;
after receiving the resource request from the client, verifying that the resource request cannot be decrypted;
sending the resource request to the hub domain controller;
in response to sending the resource request to the hub controller, receiving information regarding the resource;
sending the information regarding the resource to the client;
prior to caching the information about the client, sending a caching request to the central hub controller to cache information about to the client;
in response to sending the caching request, receiving permission to cache the information about the client;
prior to caching information about the client, determining that the client is not on a deny list.

37. The computer storage device of claim 35, wherein the encrypted secret includes a ticket granting ticket and a session key.

38. The computer storage device of claim 35, wherein the key is a client password.

39. The computer storage device of claim 38, further comprising:
in response to sending the caching request, receiving a second secret and the key from the hub domain controller.

40. The computer storage device of claim 39, further comprising:
receiving a second resource request from the client;
determining the information about the client is in the cache;
encrypting the second secret with the key;
after encrypting the second secret with the key, sending the second secret to the client.
